(19) United States
(12) Patent Application Publication
(10) Pub. No.: US 2014/0261211 A1
(43) Pub. Date: Sep. 18, 2014

(54) FISH FOOD DISPENSER

(71) Applicants: Ling Liu Tuan, Bountiful, UT (US); Charles T. Tuan, Bountiful, UT (US)

(72) Inventors: Ling Liu Tuan, Bountiful, UT (US); Charles T. Tuan, Bountiful, UT (US)

(21) Appl. No.: 14/288,675

(22) Filed: May 28, 2014

Related U.S. Application Data
(63) Continuation-in-part of application No. 14/142,500, filed on Dec. 27, 2013.
Application No. 14/142,500 is a continuation-in-part of application No. 13/796,749, filed on Mar. 12, 2013.

(51) Int. Cl. A01K 61/02; A01K 61/00; A01K 5/00; A01K 63/06

(52) U.S. Cl. CPC A01K 61/025; A01K 63/06; A01K 61/003; A01K 5/00
USPC 119/230; 119/267; 119/264; 119/51.04; 119/51.01; 15/246.5

(57) ABSTRACT

An illuminating system for illuminating a vivarium from the side panel of a vivarium using light emitting diodes. A containment ring for dispensing fish food within an aquarium. A perforated container with a lid for dispensing food within a vivarium. A brush for cleaning a vivarium. A method for soaking food in a sinking tray. A method of dispensing bait from a perforated container.

This application is a continuation-in-part of U.S. non-provisional patent application Ser. No. 14/142,500, filed on Dec. 27, 2013, entitled FISH FOOD DISPENSER, which is incorporated herein in its entirety by reference, and which is a continuation-in-part of U.S. non-provisional patent application Ser. No. 13/796,749, filed on Mar. 12, 2013, entitled FISH FOOD DISPENSER, which is incorporated herein in its entirety by reference.

### BACKGROUND OF THE INVENTION

1. The Field of the Invention

This invention is in the field of vivariums, such as aquariums, terrariums, and related devices.

2. The Relevant Technology

Vivariums, such as aquariums and terrariums, are popular in home, commercial, agricultural, and industrial settings, providing educational and recreational experiences and food sources. They are containers designed to form habitat in which animal life, such as fish, reptiles, amphibians, or mammals can exist and thrive for the benefit of a home, business and community. For example, one benefit of having an aquarium filled with aquatic life is the opportunity to view and interact with the aquatic life in a setting distant from oceans, lakes and rivers, for example.

A primary aspect of the creation and maintenance of a vivarium is providing sufficient nutrients in the form of food for the animals living in the vivarium, in proper quantities and proportion, such that the animals will be sustained, prosper, and thrive. Another responsibility is to maintain the vivarium in a clean, fragrant, and presentable fashion.

Commonly, the goal of feeding and maintaining the environment of a vivarium is complicated by the need to keep it clean. If left unattended, a vivarium can become crowded, dirty, and shrouded in unwanted films.

Another problem relating to the feeding of fish and other animals in water is that certain food, e.g. pellets, are often of a hard type that may injure the inside of an animal's mouth. Some fish swallow food without chewing it first, which can cause injuries, particularly with such hard food.

It is therefore desirable to develop systems and technologies that encourage and enhance the ability of a vivarium caretaker to feed marine life in a suitable and proper manner. It is also desirable to have cleaning systems that encourage the convenient and thorough cleaning of a vivarium.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 demonstrates a fish food dispensing assembly 10 of the present invention, assembly 10 being shown in an exploded view.

FIG. 1A demonstrates fish food dispensing assembly 10 in a magnetically coupled, perspective view without the supplemental cage 52 of FIG. 1.

FIG. 2 demonstrates assembly 10 of FIG. 1A in a front view.

FIG. 3 demonstrates assembly 10 of FIG. 1A in a rear view.

FIG. 4 demonstrates assembly 10 of FIG. 1A in a side view with FIG. 5 being an opposing side view thereof.

FIG. 6 demonstrates assembly 10 of FIG. 1A in a top view.

FIG. 7 demonstrates assembly 10 of FIG. 1A in a bottom view.

FIG. 8 demonstrates use of fish food dispensing assembly 10 mounted on an aquarium with the handle member and perforated portion magnetically linked to each other through a panel of the aquarium. Dispensing assembly 10 is shown in a vertical position with respect to the aquarium.

FIG. 9 demonstrates an alternative fish food dispensing assembly of the present assembly having a cylindrical fish food mounting post mounted on a bottom plate thereof.

FIG. 10 demonstrates the fish food dispensing assembly of FIG. 9 mounted through magnetic linking on a panel of an aquarium. Dispensing assembly 10A is shown in FIG. 10 in a slanted position with respect to the aquarium.

FIGS. 11A and 11B demonstrate cut away views of alternate perforated containers containing a foam material, which causes the containers to float in an aquarium when magnetically disengaged from the handle member.

FIG. 12 shows another example of a lid 38a movably coupled to the plate of a perforated container of the present invention.

FIG. 13 demonstrates another embodiment of a fish food dispensing assembly 110 of the present invention, assembly 110 being shown in an exploded view.

FIG. 13A demonstrates yet another embodiment of a fish food dispensing assembly 110a of the present invention, assembly 110a being shown in an exploded view.

FIG. 14 demonstrates the fish food dispensing assembly 110 in an alternate perspective view.

FIG. 15 shows an assembled view of fish food dispensing assembly 110 in use in an aquarium wherein food has been placed in a perforated container within a fish food containment ring of the assembly, enabling the food to be soaked by liquid within the container.

FIG. 15A illustrates the lowering of container 114 by moving handle member 112 downwardly such that container 114 and ring 116 (which are magnetically linked to handle member 112) both move lower such that container 114 extends below the water level. Floating fish food then exits container 114.

FIG. 16 demonstrates the fish food dispensing assembly 110 of FIGS. 13, 14, and 15, wherein the perforated container has been pressed further downward into the water and wherein the soaked floating food has been moved by the fluid in the aquarium from the perforated container to the top of the fluid in the aquarium.

FIG. 17 demonstrates the fish food dispensing assembly 110 wherein sinking food has been placed in a perforated container within a fish food ring of the assembly and wherein a lid is being mounted on the containment ring. Arrows demonstrate that the ring with the lid therein may be conveniently inverted, i.e., turned upside down, as reflected in FIG. 18.

FIG. 18 demonstrates the inverted containment ring 116 and lid 118 wherein sinking food is moving from the inverted perforated container of FIG. 17 and is maintained on lid 118 for consumption by a fish.

FIG. 19 demonstrates fish food dispensing assembly 110 mounted to aquarium 130.

FIG. 20 demonstrates an alternative handle member 112b of the present invention wherein a hook of the handle member mounts the handle member to an aquarium to thereby illuminate the aquarium and fish and objects therein.

FIG. 21A demonstrates a brush plate and handle magnetically connected on the wall of a vivarium.

FIG. 21B demonstrates an illuminating system.

FIG. 21C demonstrates an assembly that includes an illuminating system and a handle.

FIG. 21D demonstrates a remote.

FIG. 22A demonstrates a brush plate and handle magnetically connected on the wall of a vivarium.

FIG. 22B demonstrates an illuminating system.

FIG. 22C demonstrates an assembly that includes an illuminating system and a handle.

FIG. 23A demonstrates a brush plate and handle magnetically connected on the wall of a vivarium, with a clip and a blade magnetically connected to the brush plate.

FIG. 23B demonstrates a handle.

FIGS. 24A and 24B demonstrate different methods for connecting a illuminating system to a wall of a vivarium.

FIG. 25 demonstrates a fish food containment ring assembly.

FIG. 26 demonstrates system a perforated container assembly.

FIG. 27 demonstrates a fish food containment ring assembly.

FIG. 28 demonstrates an assembly with a clip and an illuminating system.

FIGS. 29A, 29B, and 29C demonstrate a fish food containment ring assembly and a method of using it.

FIGS. 30A and 30B demonstrate a hook on a linking member.

FIGS. 31A and 31B demonstrate a linking member.

FIGS. 32A and 32B demonstrate a notepad with a linking member attached to it.

FIGS. 33A and 33B demonstrate a perforated container with a lid.

FIGS. 34A and 34B demonstrate a method of using a perforated container.

FIGS. 35A and 35B demonstrate a method of using a perforated container.

FIG. 36 demonstrates an assembly including an illuminating system and a fish food containment ring.

FIGS. 37A and 37B demonstrate an assembly including an illuminating system, a perforated container, a handle, and a brush plate.

FIG. 38 demonstrates a fish food containment ring assembly.

FIG. 39 demonstrates a perforated container assembly.

FIG. 40 demonstrates a fish food containment ring assembly.

FIG. 41 demonstrates a side sectional view of a magnet assembly.

FIG. 42 demonstrates a fish food containment ring assembly.

FIG. 43 demonstrates a fish food containment ring with a cover.

FIG. 44 demonstrates a perforated container with a lid.

FIG. 45 demonstrates an assembly including a linking member, a hanger, an illuminating system, and a brush plate with a blade.

FIG. 46 demonstrates an assembly including a linking member, a hanger, and an illuminating system.

FIG. 47 demonstrates a brush plate.

FIG. 48 demonstrates a brush plate.

FIG. 49 demonstrates a brush plate.

FIG. 50a demonstrates a brush plate and FIG. 50b demonstrates an illuminating system.

FIG. 51 demonstrates a brush plate and an illuminating system.

FIG. 52 demonstrates an illuminating system.

### DETAILED DESCRIPTION OF THE PREFERRED EMBODIMENTS

FIG. 1 shows a fish food dispensing assembly 10 of the present invention. Assembly 10 comprises a handle member 12 and a perforated container 14, that are selectively, magnetically linked to each other while on opposite sides of a panel of a fish aquarium in order to clean and/or dispense food from perforated container 14 in a liquid environment (such as water). In light of the magnetic coupling, the position of container 14 can be selectively moved by moving handle 12. Liquid within an aquarium moistens fish food within the perforated container 14 and moves the fish food out of perforations in the perforated container 14.

Handle member 12 comprises a substantially flat plate 16, having an ergonomic grip 18 coupled thereto (e.g. integrally extending therefrom) for grasping handle member 12, and placing handle member 12 adjacent the panel of the aquarium. In one embodiment, a soft cleaning material 20 configured to clean and shine an aquarium panel, such as felt, cloth, textile or other non-scratch material is mounted on plate 16 in order to shine the panel of the aquarium, which may be comprised of a transparent or translucent material such as glass, plastic or other material suitable for containing liquid and visualizing marine life there-through, for example.

Plate 16 has light sources 22, e.g., light emitting diodes mounted about the peripheral surface thereof in order to attract fish toward assembly 10 where the food is and/or illuminate an aquarium. Toggle switch 26 (FIG. 3) can be used to activate light source 22 and/or rear light source 28 (FIG. 3) mounted within grip 18 which shines into a room outside the aquarium, for example. One or more batteries for light sources 22, 28 may be mounted within grip 18, for example, and electrically coupled to switch 26 and light sources 22, 28. Rather than a toggle switch 26, the switch to activate lights 22, 28 may be a rounded rotating wheel switch, one or more button switches or a variety of different switches. A remote control may optionally be used to activate light sources 22, 28.

Assembly 10 thus comprises one or more light sources 22 on the handle for illuminating the inside of the aquarium and/or rearwardly away from the aquarium. Plate 16 of the handle member 12 is greater in size than a plate 26 of the perforated container 14. One or more light sources 22 are located on the rim of the plate 16, such that the one or more lights shine past the perforated container 14 into the aquarium during use.

One or more light sources such as light source 28 and/or similar to light source 28 may be on the grip 18 for illuminating outside of the aquarium. Light source 28 may be a light emitting diode, for example.

Returning to FIG. 1, perforated container 14 comprises a substantially flat plate 26 which is configured to be mounted on the opposing side of the aquarium from handle member 12. Plate 26 has mounted thereon a brush 28, formed from bristles, cloth or other brushing material suitable for cleaning the inside surface of an aquarium panel when handle 12 is magnetically linked to container 14 is moved with respect to the aquarium.

On the opposing sides of plate 26, a curved, perforated panel 30 having apertures 50 is mounted with one side 32 of panel 30 being mounted on one end of plate 26 and an opposing side 34 of perforated panel 30 being mounted on the other end of plate 26, with panel 30 spaced from plate 26, thereby forming a cage for receiving fish food, as shown. Perforated panel 30 comprises a top non-perforated soaking shield 35 and a bottom non-perforated soaking shield 42 with perforations 50 positioned between top shield 35 and bottom shield 42. A tab member 36 is mounted at a top end of soaking shield 35 on a central edge thereof. Adjacent the top edges of panel 30, a lid 38 is movably connected to plate 26.

A clasp 40 is mounted on lid 38 so as to selectively lock lid 38 in a closed position when clasp 40 is closed against tab 36 when lid 36 is selectively, pivotally moved into a closed position, thereby selectively maintaining food within perforated container 14 except when the food exits through perforations 50. Soaking shields 35, 42 are used to retain floating or sinking food, respectively, within container 14 until the food is wet enough to disintegrate and float through openings 50. Mounted below perforated panel 30 is a floor panel 44.

As further shown in FIG. 1, container 14 includes in the perforated panel 30 thereof openings 50 that allow fish food to be dispersed therefrom in a liquid environment. In the event that a user desires to employ on a selective basis smaller openings in order to capture and selectively release less or smaller fish food in a particular instance, a supplemental cage 52 can be placed within perforated container 14, such metal cage 52 having smaller openings 54 in the cage body 56 thereof. Cage body 56 also has a hinged lid 58 in order to retain food within supplemental cage 52 that is too large to fit through openings 54. Lid 58 can be locked against body 56 with a wire, for example, or other locking mechanism or can be compressed closed by lid 38, for example.

In one embodiment, plates 16, 26 of handle member 12 and container 14, respectively, contain corresponding magnets with opposing polar relationships such that when handle member 12 and perforated container 14 are in close enough proximity to each other, they become magnetically coupled to each other in a desired aligned relationship, as shown for example, in FIG. 1A.

When handle 12 is placed on one side of a panel (e.g., glass or plastic transparent panel) of an aquarium and perforated container 14 is placed on an opposing side of the panel adjacent handle 12, a magnetic linkage occurs such that handle 12 and container 14 are magnetically linked to each other and to the panel adjacent to each other with handle 12 on one side and container 14 on the other. Then, upon moving handle 12, container 14 moves in the same direction as handle 12. Thus, when container 14 is placed inside an aquarium and handle 12 is placed outside the aquarium adjacent container 14, as shown in FIG. 8, brushing surface 28 of container 14 is positioned against the inside of an aquarium panel and shining surface 20 handle 12 is positioned against the outside of the panel, such that movement of handle 12 magnetically linked to the container 14 will operate to brush and clean the inside of the panel and shine the outside of the aquarium panel. Wherever the handle 12 is moved, the container 14 follows such that convenient brushing, cleaning, and shining takes place.

As shown in FIG. 1A, a fish food pellet 70 can be placed within perforated container. Upon placement of fish food pellet 70 in container 14, lid 38 of assembly 10 can be closed and assembly 10 can be moved to a desired location within an aquarium. By positioning assembly 10 into a desired location with respect to the aquarium, fish food pellet 70 can thus be selectively positioned within the aquarium so as to feed at a desired location within the aquarium.

For example, if it is desired to feed in a left lower corner, assembly 10 can be moved to that location without the user's hands touching the liquid such that the fish food pellet 70 can be specifically located there for bottom-feeding fish, for example. Or, if it is desired to place the container in an upper portion for top-feeding fish, assembly 10 containing pellet 70 can be moved to that location by moving handle 12 to that location, which will correspondingly drag container 14 to that desired location.

As shown in FIG. 8, for example, assembly 10 is mounted in a vertical position near the top of the aquarium adjacent water level 72. Disintegrated portions 74 of pellet 70 are shown in FIG. 8 as being released within aquarium in a desired location. If it is desired to feed fish at a lower location e.g. for bottom feeding fish, assembly 10 can be moved to the lower location, for example, by moving handle 12 magnetically coupled to perforated container 14. This simultaneously moves assembly 10 to a desired location and corresponding cleans the aquarium during such movement.

In yet another embodiment, the cleaning and feeding operations can be performed separately. For example, in one embodiment, assembly 10 is mounted on the aquarium with container 14 on the inside and without any food therein, after which the assembly 10 is moved with respect to the aquarium, thereby cleaning the aquarium. Next, assembly 10 is removed from the aquarium, or moved adjacent the water level, as shown in FIG. 8, after which food is placed therein. Assembly 10 is then allowed to feed the fish or is moved into a certain desired position for feeding fish.

By placing fish food within perforated container 14 and releasing it through perforations 50 of container 14, the fish food can be dispersed incrementally, preventing the fish from biting and swallowing large chunks of food or fish pellets which may have sharp edges and which may be too large for a fish's mouth or stomach. Food dispersed from container 14 cannot be larger than perforations 50. By thus requiring the fish food to disperse through certain sized apertures 50 by the dissolving power of the liquid water, the fish food size can be controlled so as to be dispersed in small enough chunks that are more amenable to fish's eating habits and less damaging to the fish's mouth and intestinal system.

With reference now to FIG. 9 in yet another embodiment, a mounting post 90A can be mounted in the floor panel 44A of a container 14A, which may be the same or similar to container 14, for example, in order to provide an opportunity to move a perforated or doughnut shaped fish food pellet 92A or other object into a desired location within the aquarium as reflected in FIG. 10. In such a manner, the pelletized food 92a is disbursed in a selected location. In addition, use of post 90A enables a user to introduce food, e.g. a perforated pellet 92A into an aquarium filled with water without getting the user's hands wet, among other benefits. Post 90A can be used to hold any object having a hole there through, such as a seaweed clipper, for example, which can be readily moved around the aquarium by being mounted on post 90A. Lid 94a can be used to maintain pellet 92a on post and may be selectively, threaded or press fit coupled to post, for example.

By moving container 10 or 10A to a desired location and disbursing food as desired, it is possible to more specifically place food into a more desired location as opposed to randomly placing the food. After installing pellet 92A onto post 90A, container 14A is readily moved into the water, without requiring the user to get the user's hands wet.

One exemplary method of feeding fish, which can be accomplished through the use of assembly 10 and/or assembly 10A, for example, is to initially place food, e.g. food pellet 70 (see FIG. 1A) within container 14, and closing lid 38, such that pellet 70 is partially shielded from dispersal in the water by either lower soaking plate 42 (in the case of sinking food, which will sink to the bottom of container 14) or upper soaking plate 35 (in the case of floating food, e.g., frozen food, which will float to the top of container 14), then mounting container 14 in a vertical position within water held within an aquarium such that container 14 and handle 12 are magnetically linked to each other with a panel of aquarium there between, such as shown in FIG. 8. While in the vertical position of FIG. 8, water within the aquarium will soften the food pellet 70 or a chunk or other portion of food and cause it to begin to disintegrate, but plate 42 or 35 will at least somewhat prevent the food from seeping out of container 14 into the water.

Then, upon moving handle from the vertical position of FIG. 8, for example, by turning the handle 12 in a clock-wise direction, e.g., about 235 degrees from the vertical position, container 14 (or 14A) is in a slanted position, such that floating food initially located in the top floats out of perforations 50 and sinking food initially located in the bottom likewise floats out of perforations 50. This slanted position is shown with respect to assembly 14A in FIG. 10, which is positioned about 235 degrees from the original vertical position, rotated clockwise.

One benefit of such approximately 235 degree or 225 degree rotation, for example, is that floating food initially located adjacent top panel 35 is then positioned at the bottom of the perforated container 14 and floats upwards through holes 50 and sinking food initially at the bottom of the perforated container 14 adjacent bottom panel 42 is then positioned at the top of the perforated container 14 and sinks downward through holes 50. However, any amount of rotating movement of assembly 10 from the vertical position of FIG. 8 to a slanted position that causes more food to be released through the perforations 50 can be sufficient to enhance the dispersal of food to the fish.

With reference to FIGS. 9 and 10, prior to rotating handle 12A, and therefore container 14A, food within container 14A is protected by top plate 35A and/or bottom plate 42A and is allowed to soak within water within the aquarium, thereby softening the food and preparing it for dispersal through perforations 50A. Upon rotating container 14A into the slanted position of FIG. 10, food that is shielded from dispersal by plate 35A or 42A will be begin to move, e.g., through sinking or floating, through the holes 50A as shown in FIG. 10. Thus, upon achieving the slanted position of FIG. 10, food which is now disintegrated and moistened and ready to be eaten in a more healthy manner within the sensitive mouths of fish will float out of holes 50A to be readily eaten by fish, as opposed to hardened food which has not moistened before being eaten.

The size of holes 50A also prevents fish from eating food that is bigger than the size of holes 50A, as opposed to allowing the fish to randomly eat food that is too large and may injure the mouths of the fish. Thus, after softening the food through placement in water and after rotation of container 14a to the slanted position of FIG. 10, softened food previously held in the areas adjacent shield 35 and/or shield 42 will move through the liquid out of apertures 50a for safe eating by fish.

Assemblies 10, 10A can be selectively moved vertically, horizontally and/or rotatably with respect to the aquarium. Optionally, dispensing assemblies 10 and/or 10A may also be turned on its side so that the fish can readily eat from assembly while in a horizontal orientation.

FIG. 11A shows that plate 26 of container 14 contains, in the interior thereof, one or more magnets. Specifically, magnets 100, 102 are located within outer casing 104 of plate 26. Also within casing 104 of plate 26 is a buoyant foam material 106 in sufficient quantity such that container 14 is buoyant and floats in water. Foam material 106 may be a buoyant closed cell extruded polystyrene foam, such as STYROFOAM, for example. Casing 104 of plate 26 may also be airtight in order to increase the buoyant effect of container 14 and cause it to float, but in our embodiment, foam 106 is buoyant enough to cause floatation of container 14 without casing 104 being airtight. This enables flotation even in the event of a perforation.

This floating effect allows a user to grab floating container 14, if it becomes magnetically disengaged from handle 12, without getting the user's hands wet. Thus, upon disconnection from a magnetic linkage, such as by accidentally dropping container 14 in an aquarium, container 14 readily floats, enabling a user to pull it from the water without having to place the user's hand into the bottom of a wet aquarium.

At least one of the handle member and the perforated container have a magnet therein that magnetically attracts the handle member and the perforated container to each other. In one embodiment each of the handle member and the perforated container have one or more magnets therein for accomplishing the desired attraction and relationship.

In one embodiment, magnets 100, 102 are oriented with opposite poles on the same side, such that magnet 100 has a north side against foam 106 for example, while magnet 102 has a south side against foam 106, for example. By orienting opposite poles of magnets on the same side of handle 12 in an offsetting relationship, one can enable handle 12 and container 14 to readily align and couple to each other in a desired relationship, such as shown in FIG. 1A, for example, for convenient storage, transportation, and sale.

Magnets 100, 102 may be embedded within the foam 106. Optionally, FIG. 11B shows that foam 106B, which causes container 10B to float, may be in panels of foam within casing 104B.

Advantages of assembly 10 thus include the following: Assembly 10 acts as a useful feeder to feed fish in a calculated, positionable manner without getting a user's hands wet. Assembly 10 simultaneously provides lighting to the interior of an aquarium and/or to a room. Assembly 10 provides the ability to simultaneously clean the inside and outside of the aquarium. Assembly 10 also provides a holder for holding a pellet of food or other object and for positioning the pellet or object in a liquid-filled aquarium without getting the hands of a user wet during such positioning. Assembly 10 acts as a soaker for soaking the food prior to feeding to fish, thus making the food soft and protecting the delicate lining surfaces of a fish's mouth and gastrointestinal tract from the sharp, hard edges of un-moistened food.

Food that is not eaten by the fish can be readily removed from the aquarium if desired by removing container 14 in a magnetically linked vertical motion without requiring the user to place the user's hand in the water. Floating and/or sinking food is trapped inside container 14 until the food either dissolves and moves through perforations 50 or is taken out of the fish aquarium for storage and feeding at a later time. This can prevent overfeeding and can save food that has not moved through perforations for later use.

Fish food in container 14 is allowed to expand in a liquid in a container and disintegrates before it is eaten by the fish, thereby preventing post-eating water expansion within a fish's stomach, which can damage the stomach. After the food is moist and soft, it is easier for the fish to digest and will assist in preventing overeating by the fish because the fish will eat the food while it is wet and expanded. By eating wetter, expanded food, the fish has decreased tendency to overeat. The food can be selectively placed at any height along a container, e.g. an aquarium. Floating food can be prevented by going out the top of the cage and can be kept centrally or lower in the cage as desired. Finally, food sizes are regulated by the sizes of the perforations of the cage(s), which can be selected by the user.

The assembly 10 of the present invention and similar assemblies may be used in connection with any type of container used to hold water. Thus, assembly 10 may be used in a personal, home, agricultural, retail, commercial, industrial application or a variety other types of settings. The aquarium mentioned and claimed herein may be any type of container that holds a liquid, such as water.

As yet another feature of the invention, an elongate extension handle 53a (shown in phantom lines in FIG. 1), such as a broom handle having threads on a tip thereof, may be selectively connected to handle 12 so as to move handle 12 when assembly 10 is located away from the user, such as when an aquarium is on a high shelf or otherwise located to far from the user to reach handling 12 without the use of an extension handle 53a. In one embodiment, extension handle 53a is selectively, threadedly connected to handle 12 or press fit therein or attached thereto with an adhesive.

FIG. 12 shows another example of a lid 38a movably coupled to the plate of a perforated container of the present invention.

FIG. 13 demonstrates an alternative fish food dispensing assembly 110 of the present invention comprising a handle member 112 and a perforated container 114 that are configured to be selectively, magnetically linked to each other while on opposite sides of the panel of a fish aquarium in order to clean and/or dispense food from perforated container 114 in a liquid environment (such as water). In light of the magnetic linkage, the position of container 114 can be selectively moved when moving handle member 112. Liquid within the aquarium moistens fish food within the perforated container 114 and moves the fish food out of perforations in the perforated container 114. Upon movement of handle member 112, dispensing assembly 110 moves to a selected location within an aquarium.

Handle member 112 can be exactly the same as or similar to previous handle members disclosed herein, such as handle member 12 of FIGS. 1-8, for example, handle member 12a of FIG. 9 and other handle members described herein. Thus, handle member 112 can have one or more magnets therein, for example, and further has an array of lights (or multiple arrays of lights), comprising light emitting diodes, such as discussed with respect to handle 12, for example. The LED lights of handle member 112 thus can provide one or more colors within an aquarium, illuminating fish or objects within the aquarium. In one embodiment, the one or more light emitting diodes of handle member 112 emit different colors of light, thereby illuminating the aquarium with different colors. Handle member 112 may have various lighting arrays, including a series of LEDs around the peripheral plate surface thereof, as shown in FIG. 14 and/or a variety of other arrays as may be desired to illuminate the interior of the container.

Dispensing assembly 110 further comprises: (i) a fish food containment ring 116 configured to be magnetically linked to perforated container 114 with container 114 inside ring 116; (ii) a lid 118 which can be mounted on ring 116, and (iii) a brush plate 120 which is selectively magnetically linked to handle member 112 on an opposite side of an aquarium panel from handle member 112, and which is also selectively magnetically linked to fish food containment ring 116, both of which are inside the aquarium. These relationships are also demonstrated in FIG. 14. In light of the magnetically linked relationships of the components of assembly 110, upon movement of handle member 112, dispensing assembly 110 moves to a selected location within an aquarium.

Perforated container 114 is a cage-member comprised of a perforated container body 115 and a magnet 117 mounted on the container body 115. Perforated container 114 may comprise a cup or vessel having an outer cylindrical wall and a lower plate, the wall and/or plate having perforations therein such that food can be placed within container 14 and soaked by liquid and/or exit the perforations in the presence of water or another liquid. Perforated container 114 is configured to be magnetically linked to containment ring 116 within containment ring 116 such that food dispensed from container 114 is maintained within ring 116. Ring 116 can be moved to a selected location of the aquarium by moving handle 112 to that location.

In the embodiments of FIGS. 13 and 15, a majority or all of the mass of magnet 117 of perforated container 114 is positioned on an upper portion of container body 115 (i.e., above a midpoint 135 of container body 115) to help ensure that a substantial portion of perforated container 114 is located below the water level while ring 116 floats in a position such that ring 116 contains fish food within ring 116. This positioning of the magnet 117 encourages the lower portion of the container body 115 to be positioned below the water level when the container 114 is magnetically coupled to ring 116 while inside ring 116.

Brush plate 120 is comprised of (i) a plate member 121, comprising a material (e.g., metallic) that is attracted to magnets; and (ii) a brush 123 mounted on plate member 121 so as to brush the interior of a panel of an aquarium. Brush 123, may be formed from bristles, cloth or other brushing material suitable for cleaning the inside surface of an aquarium panel when handle 112 is magnetically linked to plate 120 and handle 112 is moved with respect to the aquarium. The brush plate 120 is comprised of a material that is attracted to one or more magnets in handle 112 and ring 116, such that plate 120 can be selectively magnetically linked to containment ring 116 and such that plate 120 can be simultaneously selectively magnetically linked on opposing sides of a panel of the aquarium to handle member 112 with the aquarium panel between the handle member 112 and the brush plate 120.

Containment ring 116 is in one embodiment configured to float, such as by being formed as a hollow plastic ring or by otherwise being configured so as to float, e.g., by containing STYROFOAM or another floating material. Floating containment ring 116 assists to orient brush plate 120 in a substantially vertical position near the top of the liquid within aquarium 130. Containment ring 116 of the present invention is perhaps made from a floating material, e.g., by the ring being comprised of a hollow material or other floating material that causes the ring to float within the aquarium 130.

Containment ring 116 comprises a ring shaped member having a large aperture therethrough and having a magnet 126 thereon for magnetic linking to brush plate 120. In one embodiment, magnet 126 is coupled directly to an outside portion of ring shaped body 119 of ring 116 while another magnet 127 is coupled to an inside portion of body 119. In another embodiment, magnets 126 and 127 are integrally connected to each other and extend through body 119. Thus either a single magnet extending through body 119 or multiple magnets on opposing sides of body 119 can be employed. Lid 118 may be comprised of a plate with a rim on the edge thereof such that the rim mounts the plate onto the containment ring 116.

In one embodiment, the outer magnet 126 of ring 116 is oriented such that a magnetic attraction between ring 116 and brush plate 120 orients brush plate 120 in a substantially vertical position near the top of the liquid in aquarium 130 as shown in FIGS. 15 and 19. In this substantially vertical position, brush plate 120 can be conveniently substantially parallel and aligned with handle 112, such that brush plate 120 is conveniently, selectively, magnetically linked to handle 112 adjacent the top of the liquid in aquarium 130. The poles of the magnets in handle member 112 and/or ring 116 are positioned such that the respective handle, 112, brush plate 120, and ring 116 conveniently align with each other in an orientation in which plate 120 and handle 112 are substantially vertical and substantially parallel to each other, as shown in FIGS. 13, 14, 15, and 19 for example.

Inner magnet 117 of perforated container 114 is also configured such that container 114 is upright, as shown in FIG. 13. Thus, floating ring 116 makes the scrub plate 120 substantially parallel and convenient for magnetic linking with handle 112 and container 114.

To help orient ring 116 in a food containing position (as shown in FIG. 13), inner magnet 126 and outer magnet 127 (which may be separate or integrally connected) of ring 116 are mounted on ring body 119 such that a majority or all of the mass of inner magnet 126 and outer magnet 127 are positioned below the midpoint 133 of the ring body 119 when ring body 119 is viewed in cross section, as shown in FIG. 15. Thus, a majority or all of the mass of inner magnet 126 and outer magnet 127 are positioned on a lower portion of ring body 119. This weighting providing by locating a majority or all of the mass of magnets 126, 127 substantially below the midpoint 133 of ring body 119 orients both brush plate 120 and perforated container 114 substantially below the midpoint 133 of ring body 119, as shown in FIG. 15, thereby enabling a substantial portion of perforated container 114 to be located below the water level while ring 116 floats in a food containing position, also as shown in FIG. 15.

As shown in FIGS. 13 and 15, inner magnet 126 and outer magnet 127 (which may be separate or integrally connected) of ring 116 are mounted on ring body 119 such that more of the mass of inner magnet 126 and more of the mass of outer magnet 127 is positioned below the midpoint 133 of the ring body 119 (when ring body 119 is viewed in cross section, as shown in FIG. 15) than is positioned above the midpoint 133 of the ring body 119. Positioning the majority of the mass of magnets 126, 127 below the midpoint 133 of ring body 119 helps to insure that a substantial portion of perforated container 114 is located below the water level while ring 116 floats in a food containing position as shown in FIG. 15.

Similarly, as shown in FIGS. 13 and 15 a majority or all of the mass of magnet 117 of perforated container 114 is positioned above a midpoint 135 of perforated container 114 to further enable a substantial portion of perforated container 114 to be located below the water level while ring 116 floats in a food containing position as shown in FIG. 15.

In one embodiment, brush plate 120 is not employed, but rather containment ring 116 is directly magnetically selectively linked to handle 112. Thus, brush plate 120 can be employed if it is desired to brush and clean the aquarium 130, but brush plate 120 need not be employed if it is desired to simply magnetically link containment ring 116 to handle 112. In yet another embodiment, brush plate 120 is integrally connected to containment ring 116, such that containment ring 116 includes a brush thereon.

Perforated container 114, containment ring 116, and brush plate 120 are placed within liquid in an aquarium 130, as shown in FIG. 15, and fish food 132 is placed within perforated container 114 and allowed to soak within the liquid in aquarium 130. Floating fish food will also float upward out of container 114, but will be substantially maintained within containment ring 116, thereby substantially preventing the food from moving to all of the areas of the aquarium 130. Maintaining the fish food 132 within a designated area of the aquarium 130 helps to ensure that only a selected portion of the aquarium is affected by the untidiness and unsightly film and slime formed by fish food floating to unwanted areas of the aquarium 130. In other words, containment ring 116 contains a substantial portion of fish food 132 within a desired area of the aquarium, keeping other areas of the aquarium clean while the fish are free to eat the fish food 132.

One convenient method of magnetically linking brush plate 120 to ring 116 that is enabled by the positioning of magnets 127, 127 of ring 116 first comprises linking brush plate 120 to ring 116 with brush plate 120 oriented downwardly, such that ring 116 with the attached plate 120 float in a food containing position within aquarium 130, after which handle 112 is conveniently magnetically linked thereto. This is often more convenient than first linking brush plate 120 to handle 112, then linking ring 116 to brush plate 120 because ring 116 floats in a food containing position with plate 120 thereon and because of the increased gripping surface of the ring 116, which can be conveniently held while linking handle 112 to brush plate 120 on opposing sides of a panel of aquarium 130.

Once floating food within container 114 is soaked, as illustrated in FIG. 15, the soaked food is less sharp for the mouths of fish and is thus better for eating by the fish. In order to completely cause the floating food to move out of container 114, container 114 can then be moved completely below the water level, as shown in FIG. 15A or FIG. 16, allowing the soaked food to float out of container 114. This lowering of container 114 can be performed by (i) moving handle member 112 downwardly such that container 114 and ring 116 both move lower such that container 114 extends below the water level, as shown in FIG. 15A; or (ii) by moving container 114 with respect to ring 116 (e.g., by manually moving container 114), as illustrated in FIG. 16.

FIG. 16 demonstrates the fish food dispensing assembly 110 of FIGS. 13, 14, and 15, wherein the perforated container has been moved further downward into the water and wherein the soaked floating food has been moved by the fluid in the aquarium from the perforated container to the top of the fluid in the aquarium. According to this method of dispensing food, floating food is first soaked in the perforated container 114 as shown in FIG. 15 (soaked food being softer and therefore better for the mouths of the fish), then the perforated container 114 is moved further into the liquid such that the floating food exists the top of the perforated container, as illustrated in FIG. 16. Optionally, as illustrated in FIG. 15A, once assembly 110 is in the position of FIG. 15, after the food 132 is soaked, the entire assembly 110 can be moved downward by moving handle 112, such that perforated container 114 is moved completely below the water level, and such that soaked floating food 132 will float out of the top of container 114.

As illustrated in FIG. 16, containment ring contains floating fish food 132 in a selected position within aquarium 130, substantially preventing the fish food 132 from moving to unselected, random locations of the aquarium 130 and substantially ensuring that the areas where the containment ring is not located, are less likely to become dirty or soiled or receive a film of fish food thereon.

Lid 118 can optionally be placed on containment ring 116 in connection with the use of sinking fish food 132a, as discussed in connection with FIGS. 17 and 18.

As illustrated in FIG. 17, assembly 110 is mounted on an aquarium 130. Once sinking food 132a is placed within container 114 to soak within the liquid in aquarium 130, lid 118 can then be placed on containment ring 116. Once lid 118 is placed on containment ring, ring 116 and associated lid 118, along with perforated container 114 and plate 120 can then be inverted, i.e., turned upside down, as shown in FIG. 18. Inverting ring 116, lid 118, container 114 and plate 120 can be performed by spinning handle 112 approximately 180 degrees, for example, as illustrated by the spinning arrows of FIG. 17. This causes the sinking food 132a to move from container 114 to the now upside down lid 118, as shown in FIG. 18. Ring 116 substantially contains sinking food 132a within a desired location within the aquarium, preventing the food from contaminating undesired portions of the aquarium, as further shown in FIG. 18

Thus, containment ring contains fish food, which is floating fish food 132, or sinking fish food 132a, in a desired position within aquarium 130, preventing the fish food from moving to random areas of the aquarium 130 and ensuring that the areas where the containment ring is not located, are less likely to become dirty or soiled or receive a film of fish food thereon.

As shown in FIGS. 17-18, lid 118 can be placed on containment ring 116, such that sinking food placed within perforated container 114 sinks to the bottom of inverted containment ring 116, landing on lid 118 and being maintained in a fixed, selected position within containment ring 116. Thus, the sinking food is held in a desired position within aquarium 130, such that other areas of the aquarium are less likely to become dirty or receive a layer of fish food thereon as an unsightly film that needs to be cleaned.

FIG. 19 demonstrates fish food dispensing assembly 110 mounted to aquarium 130. Assembly 110 is configured such that the fish food dispensing assembly 110 can be moved with respect to the aquarium 130 by moving handle 112 of FIG. 13 in order to position the fish food dispensing assembly in a selected location for feeding fish within the aquarium, such that the fish food is dispensed within the selected location, substantially preventing the fish food from extending to other locations within the aquarium.

FIG. 20 demonstrates yet another embodiment of a fish food dispensing assembly 110a comprising a handle member 112b, having a hook 136 mounted thereon. In this embodiment, hook 136 maintains handle 112b on aquarium 130, while containment ring 116, brush plate 120, and perforated container 114 are selectively, magnetically linked to handle 112b.

FIG. 20 thus demonstrates an alternative handle member 112b of the present invention wherein a hook 136 of the handle member 112b mounts the handle member 112b to an aquarium to thereby illuminate the aquarium and fish and objects therein. Hook 136 is mounted on and extends from the body 137 of handle member 112b, as shown in FIG. 20.

Hook 136 may be mounted on any of the body portions 137 of the handle members disclosed herein to form handle member 112b or a similar handle member having a hook. For example, a hook 136 may be mounted on a body of handle member 12 of FIG. 1, FIG. 12A of FIG. 9, and/or handle member 112 of FIG. 13, for example to form a handle member of the present invention featuring illuminating lights that is magnetically linked to a perforated container 114 (or 14, 14A or 14B), brush plate 120, and/or containment ring 116 of the present invention. Hook may be mounted on and extend from a portion of a body of the handle member of the present invention, such as by being coupled to plate 16 or grip 18 of handle member 12 of FIG. 1, for example. Thus, in one embodiment, hook 136 is mounted on a body of handle member 12 by being coupled to plate 16 and/or grip 18 of handle member 12 of FIG. 1.

Handle 112b of FIG. 20, having hook, 136 may be used independently from brush plate 120, containment ring 116, and/or container 114, as illustrated in FIG. 20. Optionally, however, brush plate 120, containment ring 116, and/or container 114, are used in conjunction with handle 112b having hook 136. For example, in one embodiment, handle 112b is first mounted onto an aquarium 130 using hook 136 for illuminating aquarium 136 with one or more colors of lights, after which brush plate 120, containment ring 116, and container 114 are added to the aquarium, after which food is placed into container 114 as discussed with respect to FIGS. 15-19 for feeding fish.

Aquarium 130 and the dispensing assembly 110 of FIGS. 13-18 are an example of an aquatic assembly for creating an ecosystem for marine wildlife, the aquatic assembly comprising: (A) an aquarium 130 configured to contain a liquid therein with marine life existing within the liquid in the aquarium; and (B) a fish food dispensing assembly 110 configured to be mounted to the aquarium, the fish food dispensing assembly comprising: (i) a handle member 112 having light sources thereon for illuminating the aquarium to thereby attract fish toward the dispensing assembly; (ii) a perforated container 114 that is selectively, magnetically linked to the handle member, the perforated container 114 configured to receive fish food therein and to dispense fish food therefrom in a liquid environment, the perforated container 114 configured to be magnetically linked to the handle member 112, such that the fish food dispensing assembly 110 can be moved with respect to the aquarium 130 in order to position the fish food dispensing assembly in desired locations for feeding fish within the aquarium; (iii) a fish food containment ring 116 configured to be magnetically linked to the perforated container 114 and to the handle member 112 such that the fish food dispensed within the aquarium is dispensed within a specific location, substantially preventing the fish food from extending to other locations within the aquarium; and (iv) a brush plate 120 configured to be magnetically linked to the perforated container 114, the containment ring 116, and the handle 112, such that the brush plate moves against the aquarium panel when the dispenser assembly is moved with respect to the aquarium, wherein the fish food dispensing assembly can be employed to simultaneously dispense food to fish and to clean the panels of the aquarium.

A method for dispensing fish food within an aquarium 130 filled with a liquid, comprises: (A) providing an aquarium 130 filled with a liquid; (B) providing a perforated container 114 and a handle member 112 that are configured to be selectively, magnetically linked to each other; (C) providing a fish food containment ring 116 configured to be magnetically linked to the perforated container 114 and to the handle 112; (D) placing fish food within the perforated container; (E) placing the containment ring 116 within the aquarium; (F) placing the perforated container 114 within the containment ring 116 such that the containment ring 116 is inside the aquarium 130 and the perforated container 114 is on the inside of the containment ring 116 and such that the handle member is on the outside of the aquarium 130 such that the perforated container 114, containment ring 116, and the handle 112 are magnetically linked to each other, and such that the liquid within the aquarium 130 moistens the fish food within the perforated container 114 and moves the fish food out of perforations in the perforated container 114, and such that the fish food dispensed within the aquarium is dispensed within a specific location, substantially preventing the fish food from extending to other locations within the aquarium.

In an embodiment further comprising a lid 118 for covering the containment ring, a method for dispensing fish food further comprises: allowing fish food in the perforated container to soak in the liquid and inverting the perforated container such that food is moved onto the lid, as shown in FIGS. 17 and 18.

In an embodiment further comprising a brush plate 120 that is magnetically linked to the handle and/or the containment ring, the method for dispensing further comprising cleaning the aquarium using the brush plate. The method for dispensing can further comprise illuminating the aquarium 130 using the dispensing assembly 110.

As shown in FIG. 13A, in an alternative embodiment, a handle 112A of the present invention includes an electronic display panel 114 for displaying conditions within aquarium 136, such as temperature, pH, Oxygen and Nitrogen saturation, etc. Display panel 114 communicates with a sensor within aquarium, e.g., a sensor coupled to the brush plate and/or containment ring, for example. A solar panel 146 mounted on the housing of handle 112 and coupled to rechargeable batteries within handle 112a can be employed to power the lights and/or the electronic display panel 144. As shown in FIG. 13a, an extension handle 129, e.g., as discussed with respect to FIG. 1, can be linked to the handle member 112a (and/or handle 112) for reaching difficult to reach aquariums.

Magnetic linking or similar terms as described and claimed herein may comprise orienting corresponding magnets with opposing polar relationships such that items become magnetically linked when the items are in close enough proximity to each other to become magnetically linked, or it may comprise magnetically linking one or more magnets to a member that is attracted to magnets such as a metallic member. As used in this application, “linking member” refers to either a magnet or a member that is attracted to magnets such as a metallic member.

Description of elements of the assembly of one embodiment may also apply to the same or similar elements in a different embodiment without needing to be repeated every time that element is included.

In one embodiment, as shown in FIG. 21A, an aquarium assembly or terrarium assembly includes a brush plate 120 that is magnetically linked to a handle 200 across a panel 202, such as a side panel, of an aquarium or terrarium. Vivariums typically have a bottom panel extending substantially horizontally, and at least one side panel extending substantially perpendicularly with respect to the bottom panel. For example, many vivariums are rectangular cuboids such as those shown in FIGS. 10 and 19. In both of these figures, an assembly is shown located on a side panel of the vivarium.

The handle 200 comprises an inner surface 204 that comprises a material suitable for polishing or shining the exterior surfaces of the vivarium. The handle 200 comprises indented surfaces 218 to allow for easier gripping of the handle.

The handle 200 is able to selectively couple with an illuminating system 206, as show in FIG. 21C, to form an illuminating assembly. (The front side 228 of illuminating system 206 is shown in FIG. 24A, and the back side 230 can be seen in FIG. 21C.) Such coupling may be magnetic linking, or based on corresponding sizes and shapes of the handle 200 and illuminating system 206, or some other method of coupling. As shown in FIGS. 37A and 37B, the handle 200 fits inside a cavity 208 of the illuminating system 206. The cavity 208 extends into the front side 228 of the illuminating system 206. Other coupling mechanisms configured for coupling an illuminating system such as 206 to a side panel or other surface of a vivarium, such as an aquarium or terrarium, are discussed below. The coupling mechanism may comprise a selective coupling mechanism configured to selectively couple the illuminating system to the side panel of a vivarium.

When an illuminating system such as 206 is coupled to a side panel or other surface of a vivarium, this illuminates the vivarium or otherwise provide light for humans viewing the organisms living in the vivarium or light for the organisms themselves. An illuminating system such as 206 may also include a linking member 236 embedded within or attached to a housing 245. All of the systems and assemblies disclosed in this application may be located on a side panel of a vivarium.

As shown in FIGS. 24A and 24B, the illuminating system 206 has one or more LED lights 216, an energy source 298, and a control element 210 for controlling the one or more LED lights. The lights 215, control element 210, energy source 298, and any needed electronic elements for connecting these features are all included within a housing 245. While LED lights are intended to be used in this system, it is possible that other types of lights could be used. An energy source may comprise batteries located inside the illuminating system, a solar power converter that converts solar power into energy useable by the one or more LED lights, or energy from an external power source, such as a power cord that connects to a wall outlet. As shown in FIG. 24B, the energy source 298 is a power cord. As shown in FIG. 24B, the control element includes one or more buttons 210 on the illuminating system, which can be used to control the LED lights, such as by turning them on and off, making them blink or, or changing their color. An alternative control element which may be used in addition to or instead of a button 210 is a remote controller 212, as shown in FIG. 21D. A remote controller 212 includes one or more buttons 214. The LED lights 216 may, for example, flash, blink, appear to “move” by turning on and off in a sequence, or come in a variety of colors. All of the illuminating systems disclosed in this application have one or more LED lights 216, an energy source 298, and a control element 210 for controlling the one or more LED lights contained in a housing 245.

In another embodiment, shown in FIGS. 22A, 22B, and 22C, an illuminating system 232 is configured to be coupled to a handle 218. The handle 218 includes a slot 220 through which a user may place his or her fingers when manipulating the handle 218. The illuminating system 232 has a cavity 222 that extends from the front side 224 of the illuminating system 232 to the back side 226 of the illuminating system 232. This permits the handle 218 to be more easily inserted into and removed from the illuminating system 232. The handle 218 may be magnetically linked to a brush plate 120, as shown in FIG. 22A, a fish containment ring 116, or a perforated container 114, or to any combination of these.

As shown in FIG. 21B, in another embodiment, in another embodiment an illuminating system 234 is configured to be magnetically linked to other things. The illuminating system 234 comprises a linking member 236 attached to the housing 245. The linking member 236 may be magnetically linked to any of the elements disclosed as configured for being located on the inside of a vivarium.

Each of these illuminating systems 206, 234, 232, 206, and 326 is configured to be located on the outside of a vivarium. The illuminating systems may be used like a handle to move anything inside a vivarium panel that is magnetically linked the panel to the illuminating system. An illuminating system may be part of an illuminating assembly configured for illuminating the aquarium. For example, one embodiment of an illuminating assembly comprises an illuminating system and a brush plate on the inside of the vivarium. Another embodiment of an illuminating assembly comprises an illuminating system, a brush plate configured to be connected to the illuminating system on the outside of the vivarium, and a containment ring. Another embodiment of an illuminating assembly comprises an illuminating system and a hanger. An illuminating system may comprise an illuminating system in combination with any of the elements described in this application.

In addition to a brush plate 120, a fish containment ring 116, or a perforated container 114, or any combination of these, another element configured for being located on the inside of a vivarium is a clip 238. A clip 238, as illustrated in FIG. 23A, is configured to be magnetically linked to an illuminating system, a brush plate, or any other element. The clip 238 is configured to hold a piece of seaweed 241.

Another element configured for being located on the inside of a vivarium is a blade 240. A blade 240 comprises any material, such as metal or plastic material, whether hard or soft, and functions similar to a scraper or squeegee. The blade is configured to be magnetically linked to an illuminating system, a brush plate, or any other element. A user uses the blade to scrape or squeegee the inside surface 242 of the vivarium. This helps clean the inside surface 242 and remove substances such as algae. By moving a handle such as handle 200 around on the outside surface 244 of the vivarium, the blade 240 may be moved around on the inside surface 242.

FIGS. 24A and 24B illustrate two of the ways in which an illuminating system 206 is configured to be coupled to a vivarium. As shown in FIG. 24A, the illuminating system 206 has a loop 246 by which the system may be suspended. The loop 246 is mounted on the housing 245 of the illuminating system. The loop 246 may be used in a variety of ways to couple the illuminating system with the vivarium. For example, there may be a hanger 248 capable of being selectively connected to the loop 246. The hanger 248 is configured to suspend the illuminating system from the panel, such as an edge of the panel 252. For example, as shown in FIG. 24A, the hanger 248 comprises a hook 250 configured for resting on the edge of the panel 252.

As shown in FIG. 24B, the illuminating system 206 is selectively coupled to a vivarium by selectively connecting a suction device 254 to the loop and connecting the suction device 254 to the vivarium. The suction device 254 is connected to the illuminating system 206 by a hanger 256.

FIG. 25 shows a fish food containment ring assembly. The fish food containment ring 116 may be made in whole or in part of a buoyant material so that the containment ring 116 floats at the surface of water when it is placed in water and it is not magnetically linked to something across the panel of an aquarium. The fish food containment ring comprises a linking member 264.

The fish food containment ring 116 is capable of being magnetically linked across the panel of an aquarium to a linking member 258 that is configured to be placed on an outside surface of an aquarium panel. The linking member 258 has a hook 260 extending from it. The fish food containment ring 116 is configured to be magnetically linked to the linking member 258 while the containment ring 116 is on an opposite side of the aquarium panel from the linking member 258, such that the containment ring 116 can be moved with respect to the aquarium by moving the linking member 258 in order to position the containment ring 116 in a selected location for feeding fish within the aquarium and such that the fish food is dispensed from the selected location, substantially preventing the fish food from extending to other locations within the aquarium. For example, floating fish food may largely remain in the ring 116 if it is placed near or at the surface of the water. When magnetically linked together, this linking member and containment ring 116 form a fish food dispensing assembly.

As illustrated in FIG. 27, various patterns or illustrations may be affixed to, embedded within, or otherwise made a part of the containment ring 116. This may include, for example, a fluorescent color or decorative material.

FIG. 26 shows a perforated container assembly. The perforated container 114 is capable of being magnetically linked across the panel of a vivarium to a linking member 258 with a hook 260 extending from it. The perforated container comprises a linking member 262. The perforated container 114 is configured for being located on the inside of a vivarium.

FIG. 28 shows an illuminated system assembly with an illuminating system 266, a linking member 258 with a hook 260 extending from it, and a clip 238. The clip is magnetically linked to the linking member 258 across the panel of a vivarium, and the loop 246 of the illuminating system 266 hangs from the hook 260 on the outside of the vivarium.

FIG. 29A illustrates a containment ring 116 with a perforated cover 268 affixed to it. The perforated cover 268 is configured to be selectively attached to the containment ring 116. As pictured, the perforated cover 268 is attached to the bottom end 272 of the ring 116. However, the perforated cover 268 is configured to be affixed to either or both of the top end 270 or the bottom end 272 of the ring 116. If the cover 268 is, for example, configured to be affixed to the top end 270 of the ring 116, the ring may be rotated so that the top end 270 is in the position of the bottom end 272. The perforations 278 are large enough to permit water to flow through but small enough that fish food 274 does not pass through, or only very small pieces of fish food may pass through the perforations.

FIGS. 29B and 29C illustrate a method for dispensing fish food within an aquarium filled with a liquid using a containment ring 116 with a perforated cover 268 affixed to it. The perforated cover 268 should be placed at the bottom end 272 of the containment ring 116 (or placed at the top end 270 and the containment ring 116 be rotated so that the perforated cover 268 is in the position of the bottom end 272). The containment ring 116 with the cover 268 affixed to it may be placed into an aquarium filled with water. Fish food 274 may be placed into the containment ring 116 before or after the ring 116 is placed in the aquarium. The containment ring 116 may initially be placed at or near the surface 276 of the water, such that the edge (270 or 272) of the containment ring which is opposite to the edge (270 or 272) to which the perforated cover 268 is attached is located above the surface 276 of the water. In this position, no food 274, or only very small particles of food 274 which can pass through the perforations 278 in the cover 268, can be accessed by the fish 280 or other aquatic life. The containment ring 116 with a cover 268 affixed to it may be considered a sinking tray.

The containment ring 116 may be left in this position, which is pictured at FIG. 29B, for a period of time long enough to soften or moisten the fish food or any other period of time. The containment ring 116 may be capable of floating in this position, or it may be held in this position by being magnetically linked to a linking member 258 on the outside of the aquarium wall 202. The linking member 258 of FIGS. 29B and 29C is shown with a hook 260 extending from it, but it is understood that the linking member on the outside of the aquarium could comprise any number of things, such as a handle 200 or 218 or an illuminating system 234 or 206.

After the containment ring 116 is left in a position with the edge opposite to the cover 268 located above the surface 276 of the water for a period of time, the containment ring 116 is lowered to a position as shown in FIG. 29C. In 29C, the edge (270 or 272) of the containment ring 116 opposite to the cover 268 is lowered below the surface 276 of the water. By being magnetically linked to a linking member 258 across the aquarium panel 202 from the containment ring 116, the ring 116 may be held in a position such that the end (270 or 272) of the containment ring 116 opposite to the cover 268 is located below the surface of the water.

For food 274 that sinks in water, the food may largely remain in the ring 116 when it is lowered, as long as it is lowered sufficiently gradually. By keeping the food 274 in the ring 116, any uneaten food is easily removed by raising the ring 116 and removing it from the aquarium. For food 274 that floats, the food may float out of the ring 116 when it is lowered. Lowering the sinking tray into the water so that fish 280 may access the food 274 from above the cover 268 may be considered dispensing the fish food from within the tray. Dispensing food 274 from within the tray may substantially prevent the fish food from extending to other locations within the aquarium.

FIGS. 30A and 30B illustrate a linking member 258 with a hook 260 extending from it that is configured to be placed on an outside or inside surface of a vivarium panel. FIGS. 31A and 31B illustrate a linking member 258. Linking member 258 is configured to be located across a vivarium wall or other panel from, for example, an illuminating system such as 234, a brush plate 116, a note pad 282, a perforated container 114, a containment ring 116, a clip 238, a blade 240, handle 200 or 218, another linking member 258, or various combinations of these elements. A piece of seaweed or other food may be positioned between an inside surface of the vivarium and a linking member located on the inside surface of the vivarium.

As used in this application, a linking member 258 may refer to a stand-alone linking member such as that pictured in FIGS. 30A and 30B In addition, reference to a linking member 258 may also refer the linking member that is embedded into or attached to any of the elements described in this application as being capable of being magnetically linked, such as an illuminating system such as 234, a brush plate 116, a note pad 282, a perforated container 114, a containment ring 116, a clip 238, a blade 240, and a handle 200 or 218.

FIGS. 32A and 32B illustrate a note pad 282 comprising sheets of paper 284. The note pad 282 has a linking member 286 affixed to the back surface 287 of the note pad. The note pad 282 is configured to be magnetically linked to a linking member that is located on the inside of a vivarium. By permitting a user to affix the note pad 282 to a location on the outside of a vivarium, the notepad 282 may be more easily used to help an animal caretaker, or group of animal caretakers, to keep and display records and notes such as notes regarding when or how the animal was fed or when or how it needs to be fed.

FIGS. 33A and 33B illustrate a perforated container 114 with a lid 288 selectively coupled to it. The perforated container 114 is a cage-member comprised of a perforated container body 115 and a linking member 117 mounted on the container body 115. Perforated container 114 comprises a cup or vessel having an outer cylindrical wall and a lower plate. As shown, a lid 288 is placed on the container body 115 of the perforated container 114. The lid 228 has a door 290. As shown in FIGS. 33A and 33B, a door 290 are configured to be opened or closed by sliding the door 290 in relation to the lid 288. The door 290 may also be opened and closed with a hinge or other mechanisms. The door 290 selectively cover an opening 292 in the lid 288 of the perforated container 114. The lid 228 may also have an opening 292 in it without having a door 290. The size of the opening 292 and size of the perforated container 114 may vary depending on how large the bait or food in the container 114 is.

As shown in FIGS. 34A, 34B, 35A, and 35B, bait, such as live animals, for example, crickets, small fish, ants, worms, and so forth, may be placed in the perforated container 114. The perforated container 114 is then be placed in a vivarium and magnetically linked to a linking member, an illuminating system such as 234, the note pad 282, a clip 238, handle 200 or 218, a linking member 258, or various combinations of these elements.

Using a perforated container 114 to introduce bait into the vivarium is one way to allow an animal caretaker to dispense food 294 such as live bait to an animal 280 in the vivarium. Such animal 280 or animals 280 may include fish, turtles, or snakes, for example. As used in this application, reference to “fish food” may refer to food for any type of animal that can be placed in a vivarium. Using a perforated container 114 may further comprise rotating a handle 200 or 218 or other element located on the outside of the vivarium to facilitate removal of the food 294 from perforated container 114, as shown in FIGS. 34B and 35B. Dispensing food 294 with a perforated container 114 may permit a more controlled way to introduce or otherwise dispense the food 294 into a vivarium. When a user places a perforated container within the vivarium and places a linking member outside of the vivarium, such that the perforated container is magnetically linked to the linking member, the bait may be able to escape from the perforated container into the vivarium.

A perforated container 114 may also be used in a method similar to a containment ring 116 in order to soak food prior to dispensing it. In either the perforated container 114 or the containment ring 116, a large block of food (sometimes referred to as a “weekend block”) may be used. This type of block of food gradually separates for access by the fish. A weekend block 274 may be placed in a containment ring 116 with a cover 258 placed at its bottom end 272 (or at its top end 270 and with the ring rotated so that the cover is in a bottom position). The weekend block may be lowered into the aquarium for access by the fish, and at any time the weekend block may be raised out of the aquarium for easy removal of any uneaten portion.

If a perforated container 114 is used to soak food prior to dispensing it, it may also be used with a containment ring 116. For example, as shown in FIG. 17-18, food is placed in the perforated container 114, and the container 114 and ring 116 is magnetically linked across the panel of an aquarium from a linking member 258 and positioned so that the food in the container 114 is located in water. The ring 116 is positioned with a cover 296 attached to the ring 116 such that, when the food is sufficiently soaked, the assembly is rotated and the food falls out onto the ring 116. In this way, a user may avoid having the food spread around the tank.

Similarly, if a particular type of food floats, it may be soaked in the perforated container 114 and then the perforated container 114 and ring 116 assembly then lowered so that the fish food floats out of the perforated container 114 but is retained within the containment ring 116 and is accessible by animals in the aquarium. This may contain the food to the containment ring 116, to reduce the distribution of the food around the aquarium.

FIGS. 36-41 illustrate a few more ways of combining the elements into various assemblies on the panel of a vivarium. It is understood that for any of these embodiments, elements may be removed or added to the embodiment as needed or preferred.

As shown in FIG. 36, a containment ring 116 is magnetically linked to an illuminating system 232, with the containment ring 116 located on the inside of the panel 202, and the illuminating system 232 located on the outside of the panel 202. FIG. 36 is shown with a cover 296 attached to the containment ring 116.

As shown in FIGS. 37A and 37B, a perforated container 114 is magnetically linked to a brush plate 120 and both are located on the inside of a vivarium panel 202, across from and magnetically linked to a handle 200 which is located on the outside of the vivarium. The handle 200 is shown located inside a cavity 208 of the illuminating system 206. The perforated container 144 may have a lid 288 as shown in FIG. 37B, or not, as shown in FIG. 37A.

FIG. 38 shows a handle 200 magnetically linked to a containment ring 116. The handle 200 is located on the outside of the vivarium panel 202 and the ring 116 is located on the inside of the vivarium.

FIG. 39 illustrates a brush plate 120 magnetically linked to a perforated container 114. Both are located on the inside of a vivarium panel 202, across from and magnetically linked to a linking member 258 with a hook 260 extending from located on the outside of the vivarium.

FIG. 40 illustrates a brush plate 120 that is magnetically linked to a containment ring 116. Both are located on the inside of a vivarium panel 202, across from and magnetically linked to a linking member 258 located on the outside of the vivarium.

FIG. 41 illustrates a linking member 258 that is magnetically linked to a linking member 258 with a hook 260 extending from it. The linking member 258 is located on the inside of a vivarium panel 202 and the linking member 258 with a hook 260 is located on the outside of the vivarium panel 202. On the inside of the vivarium panel 202, between the linking member 258 and the panel 202, is a piece of seaweed 241. The linking member 258 holds the piece of seaweed 241 to the vivarium panel.

FIG. 42 shows a fish food containment ring assembly. A containment ring 116 is magnetically linked to a perforated container 114. The perforated container 114 has a lid 288. The lid 288 slides to open the perforated container 114. The containment ring 116 has a lip 300 facing radially inward at its top end 270. The lip 300 comprises one or more section extending toward the center of the ring 116. (The ring 116 could also or instead have a lip 300 at its bottom end 272.)

FIG. 43 demonstrates a fish food containment ring 116 with a cover 268. The cover 268 may have an opening, teeth, or ridges (not shown) that are configured to interact with the lip 300. The cover 268 may be placed in the ring 116 and then rotated (optionally using the circular handle 302, an optional circular section of the cover 268 that extends outward from the plane of the cover 268 on either one or both sides of the cover, to rotate it). Rotating the cover 268 may allow for the lip 300 to engage with a corresponding structure on the cover 268 (such as an opening, teeth, or ridges) to lock the cover 268 in position. In this way, the ring 116 can be flipped about 180 degrees with the cover 268 attached and the cover 268 may stay in place. Other means for selectively connecting the cover 268 to the ring 116 may also be used.

As shown in FIGS. 43 and 44, linking members 264 are used to magnetically link various parts of the different assemblies to each other, such as the ring 116 and container 114 shown here.

FIG. 44 shows a perforated container 114 with a lid 288. The perforated container 114 has a slot 304 cut from it, near the top end of the container 114. This leaves a small section 306 of the container 114 near the top end of the container 114 that the lid 288 slides below. The section 306 and slot 304 are configured to help hold the lid 288 in a closed position. The lid 288 has a bend 308 which can be used to help grip the lid 288 and slide it in and out of the slot 304. As shown in this figure, both the cover 288 and perforated container 114 have perforations 310.

FIG. 45 demonstrates an assembly including a linking member 312, a hanger 314, brush plate 120, and an illuminating system 316. As shown, the linking member 312 and brush plate 120 would be located on the inside of the aquarium panel and the illuminating system 316 and hanger 314 would be located on the outside of the aquarium panel. The lights 216 are positioned on the illuminating system 316 so that they are visible around the brush plate 120 located on the inside of the aquarium panel. FIG. 45 also shows a charger hole 315 into which a charger connected to an external power source is plugged.

FIG. 46 demonstrates an assembly including a linking member plate 312, a hanger 314, and an illuminating system 316. As shown, the linking member 312 would be located on the inside of the aquarium panel and the illuminating system 316 and hanger 314 would be located on the outside of the aquarium panel. On the back of the illuminating system 316 is shown a switch 318 which can be used to turn the illuminating system 316 on, off, and to change the color of the lights. The illuminating system 314 may be substantially planar on a surface to be located adjacent to the aquarium panel. The overall shape of the illuminating system may be square, rectangular, oval, or another shape.

More than one illuminating system may be used at one time. For example, two illuminating systems may be used, each on an opposite end of the aquarium from each other.

FIGS. 47 and 48 demonstrate a brush plate 120 with a blade 240 that is magnetically linked to a brush plate 326. These two brush plates 120 and 326 are configured to be magnetically linked on opposite sides of a vivarium panel from each other. Visible in FIG. 47 is the back side of the brush plate 120. The brush plate 120 is configured to be located on the inside of a vivarium such as an aquarium.

Visible in FIG. 48 is the back side 328 of the brush plate 326. The back side has a grooves 329 that are configured to selectively connect with protrusions 331 in an illuminating system. The back side 328 also has a latch 320 that is configured to selectively connect with a slot 333 in an illuminating system. By connecting the grooves 329 with the protrusions 331, and the latch 320 with the slot 333, the brush plate 322 is connected to an illuminating system 316. In addition to the features as pictured, alternative mechanisms for selectively attaching the brush plate 322 with the illuminating system 316 may include magnetic linking or a different arrangement of protrusions and grooves or latches and slots.

FIG. 49 shows the front side of a brush plate 120. The front side of the brush plate 120 has a brush material 324 affixed to it.

FIG. 50a shows a brush plate 326 and FIG. 50b shows a corresponding illuminating system 316. The illuminating system 316 and brush plate 326 are configured so that the back 328 of the brush plate 326 corresponds in shape to an opening 330 in the front of the illuminating system 316. The illuminating system 316 and brush plate 326 may be configured to be selectively connected to each other and both located on the outside of a side panel of a vivarium. The brush plate 326 may support the illuminating system 316, so that the illuminating system 316 is held up to the side panel of the vivarium because it is placed around the brush plate 326. The surface 332 on the front side of the brush plate 326 configured to be placed against a side panel of a vivarium comprises a material suitable for polishing, shining, or cleaning the exterior surfaces of the vivarium. The brush plate 326 and illuminating system 316 may be used separately from each other as well.

The brush plate 326 is coupling mechanism comprising a brush plate configured to be selectively coupled to the illuminating system 316. In one embodiment of an illuminating assembly, the brush plate 326 is configured to be selectively mounted within an opening 330 in the illuminating system 316 such that when the brush plate 326 and the illuminating system 316 are coupled and placed on a vivarium panel, a front face of the brush plate 326 is configured to be flush with the side panel while a front face of the illuminating system 316 is configured to be offset from the side panel or another panel of the vivarium.

The assembly of claim 14, wherein the offset face of the illuminating system enables the illuminating system to illuminate a portion of the panel so that a user may determine if a space on the panel adjacent to the brush plate needs to be cleaned. The distance 334 may also make it easier to separate the illuminating system 316 from the brush plate 326.

FIG. 60 shows a brush plate 326 and corresponding illuminating system 316 selectively coupled to each other. The brush plate and illuminating system are configured so that there is an approximately 1-10 millimeter distance 334, and in one embodiment, about 5 millimeter distance, between the front 336 of the illuminating system housing 245 and the vivarium panel.

By having a brush plate 326 as a separate element from the illuminating system 316, if the surface 332 of the brush plate 326 becomes worn out or dirty, the brush plate 326 can be replaced without needing to replace the illuminating system 316. Also, then the illuminating system 316 and brush plate 326 can both be used independently of each other, if desired.

Different brush plate surfaces 332 may be used depending on the material from which the panel is made, or depending on treatments or finishes on the exterior surface of the panel. Having the brush plate 326 as a separate element from the illuminating system 316 permits a variety of different brush plates to be coupled to the same illuminating system 316.

FIG. 52 shows another embodiment of an illuminating system 316. The illuminating system 316 has a housing 245 on which is mounted a loop 246. The illuminating system comprises lights 216 which are located inside circular orifices 338. The illuminating system has an opening 330 on its front side with protrusions 331 and a slot 333.

By having a distance between the front of the illuminating system housing and the vivarium panel, for example, 5 millimeters, the illuminating system is offset from the vivarium panel and will therefore illuminate the panel and help make visible dirt, dust, or other particulate matter located on the panel in order to enable the outside of the panel to be more easily cleaned.

Any of the parts of the assemblies which are configured to be placed on the inside of a vivarium, such as a containment ring 116, perforated container 114, brush plate 120, clip 238, linking member 258, or blade 240, may be configured to be able to float at or near the surface of water when attached to a containment ring 116. In this way, when any of these elements is dropped into the aquarium while magnetically linked to the containment ring 116, it will float and thus be easier to retrieve from the aquarium.

Moving the parts of the assemblies located on the outside of the vivarium that are magnetically linked to parts of the assemblies on the inside of the vivarium will move the parts on the inside of the vivarium.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An illuminated aquarium assembly comprising:
an aquarium with a bottom panel extending substantially horizontally, and at least one side panel extending substantially perpendicularly with respect to the bottom panel; and
an illuminating assembly configured for illuminating the aquarium, the illuminating assembly comprising an illuminating system and a coupling mechanism, the coupling mechanism configured to couple the illuminating system to the side panel such that the aquarium is illuminated from the side.

2. The assembly of claim 1, wherein the illuminating system comprises one or more LED lights, an energy source, and a control element for controlling the one or more LED lights.

3. The assembly of claim 1, wherein the coupling mechanism comprises a loop mounted on housing, by which the illuminating system may be suspended.

4. The assembly of claim 3, comprising a hanger connected to the loop and configured to suspend the illuminating system from the panel.

5. The assembly of claim 3, comprising a suction device selectively connected to the loop and also selectively connected to the panel.

6. The assembly of claim 1, wherein the coupling mechanism comprises a hook connected to a first linking member which is configured to be magnetically linked to a second linking member located on the inside of the aquarium.

7. The assembly of claim 1, wherein the assembly further comprises a first linking member configured to be magnetically linked to a second linking member located on the inside of the aquarium.

8. The assembly of claim 1, wherein the assembly further comprises a containment ring configured to be magnetically linked to the illuminating system.

9. The assembly of claim 8, wherein the assembly further comprises a perforated cover configured to be selectively attached to the containment ring.

10. The assembly of claim 1, wherein the assembly further comprises a perforated container configured to be magnetically linked to the illuminating system.

11. The assembly of claim 1, wherein the assembly further comprises a linking member configured to be magnetically linked to the illuminating system.

12. The assembly of claim 1, wherein the coupling mechanism comprises a selective coupling mechanism configured to selectively couple the illuminating system to the side panel.

13. The assembly of claim 1, wherein the coupling mechanism comprises a brush plate configured to be selectively mounted within the illuminating system.

14. The assembly of claim 13, wherein the brush plate is configured to fit within an opening in the illuminating system such that when the brush plate and the illuminating system are assembled, a front face of the brush plate is configured to be flush with the side panel while a front face of the illuminating system is configured to be offset from the side panel.

15. The assembly of claim 14, wherein the offset face of the illuminating system enables the illuminating system to illuminate a portion of the panel so that a user may determine if a space on the panel adjacent to the brush plate needs to be cleaned.

16. A fish food dispensing assembly comprised of:
a linking member configured to be placed on an outside surface of an aquarium panel; and
a fish food containment ring configured to be magnetically linked to the linking member while the containment ring is on an opposite side of the aquarium panel from the linking member, such that the containment ring can be moved with respect to the aquarium by moving the linking member in order to position the containment ring in a selected location for feeding fish within the aquarium and such that the fish food is dispensed from the selected location, substantially preventing the fish food from extending to other locations within the aquarium.

17. The assembly of claim 16, wherein the containment ring is located at the surface of water located in the aquarium and used with food that floats.

18. The assembly of claim 16, wherein the containment ring comprises buoyant material such that, when the fish food containment ring is not magnetically linked to the linking member, the containment ring floats at the surface of water when placed in water, even when other elements are magnetically linked to the containment ring.

19. The assembly of claim 16, wherein the assembly further comprises a brush plate configured to be located between the aquarium panel and the containment ring and also configured to be connected to the containment ring.

20. The assembly of claim 19, wherein the containment ring floats at the surface of water even when the brush plate is magnetically linked to the containment ring.

21. The assembly of claim 16, wherein the assembly further comprises a perforated cover that is configured to be selectively attached to the containment ring.

22. The assembly of claim 16, wherein the containment ring is used as a sinking tray with food that sinks.

23. The assembly of claim 16, wherein the assembly further comprises a notepad, illuminating system, button, or hook.

24. The assembly of claim 16, wherein the fish food containment ring has a fluorescent color or decorative material.

25. The assembly of claim 16, wherein the linking member is a magnet.

26. The assembly of claim 16, wherein the linking member is a member that is attracted to magnets.

27. A food dispensing assembly comprised of:
a linking member configured to be placed on an outside surface of a container configured for holding animals; and
a perforated container configured to receive food therein and dispense food therefrom; the perforated container configured to be magnetically linked to the linking member while the perforated container is on an opposite side of a container panel of the animal-holding container from the linking member, such that the perforated container can be moved within the animal-holding container with respect to the container panel by moving the handle member, in order to position the perforated container in a selected location or orientation within the animal-holding container.

28. The assembly of claim 27, wherein the animal-holding container is an aquarium.

29. The assembly of claim 27, wherein the animal-holding container is a terrarium.

30. The assembly of claim 27, wherein the perforated container further comprises a lid selectively connected to the perforated container.

31. The assembly of claim 30, wherein the lid comprises a slideable door.

32. The assembly of claim 27, wherein the linking member comprises a linking member with a hook extending therefrom.

33. The assembly of claim 27, further comprising an illuminating system, the illuminating system configured to be selectively connected to the hook.

34. The assembly of claim 27, wherein the food is bait.

35. A vivarium cleaning assembly comprised of:
a linking member configured to be placed on an outside surface of a vivarium configured for holding animals; and
a brush plate, the brush plate configured to be magnetically linked to the linking member while the brush plate is on an opposite side of a panel of a vivarium from the linking member, such that the brush plate can be moved with respect to the panel by moving the linking member, wherein the brush plate further comprises a blade attached to the brush plate.

36. The assembly of claim 35, further comprising a buoyant containment ring that is magnetically linkable to the brush plate, such that the brush plate and ring float when detached from the linking member.

37. The assembly of claim 35, further comprising a perforated container that is magnetically linkable to the brush plate.

38. The assembly of claim 35, further comprising a second linking member that is located on the interior of the vivarium and is magnetically linkable to either the brush plate or the first linking member.

39. The assembly of claim 38, wherein a piece of seaweed or other food is positioned between an inside surface of the vivarium and the second linking member.

40. The assembly of claim 35, further comprising an illuminating system that is magnetically linkable to the brush plate.

41. The assembly of claim 35, where the linking member is a magnet.

42. The assembly of claim 35, where the linking member is a member that is attracted to magnets.

43. A method for dispensing fish food within an aquarium filled with a liquid, comprising:
providing an aquarium filled with a liquid;
providing a sinking tray and a linking member that are configured to be selectively, magnetically linked to each other;
placing fish food within the sinking tray;
placing the sinking tray within the aquarium and placing the linking member outside of the aquarium, such that the sinking tray is magnetically linked to the linking member; and
positioning the sinking tray so that the upper edge of the tray is above the surface of the water and such that the liquid within the aquarium moistens the fish food within the sinking tray.

44. A method as recited in claim 43, further comprising lowering the sinking tray so that the fish food is dispensed from within the sinking tray, the sinking tray substantially preventing the fish food from extending to other locations within the aquarium.

45. A method for dispensing bait within a vivarium configured for holding animals:
providing a vivarium configured for holding animals;
providing a perforated container and a linking member that are configured to be selectively, magnetically linked to each other;
placing bait within the perforated container; and
placing the perforated container within the vivarium and placing the linking member outside of the vivarium, such that the perforated container is magnetically linked to the linking member, and such that the bait is able to escape from the perforated container into the vivarium.

46. A method as recited in claim 45, wherein the perforated container is a cage-member comprised of a perforated container body and a magnet mounted on the container body.

47. A method as recited in claim 45, further comprising the step of rotating the perforated container after it is placed within the vivarium.

48. An illuminating assembly for illuminating a vivarium, comprising:
an illuminating system; and
a brush plate configured to be selectively coupled to the illuminating system such that when the brush plate and the illuminating system are coupled and placed on a vivarium panel, a front face of the brush plate is configured to be flush with the panel while a front face of the illuminating system is configured to be offset from the panel.

49. The assembly of claim 48, wherein the offset face of the illuminating system enables the illuminating system to illuminate a portion of the panel so that a user may determine if a space on the panel adjacent to the brush plate needs to be cleaned.

50. The assembly of claim 48, wherein the brush plate is selectively mounted within the illuminating system.
